(19) United States
(12) Patent Application Publication
(10) Pub. No.: US 2025/0091953 A1
(43) Pub. Date: Mar. 20, 2025

(54) QUICK-DRYING LIGHTWEIGHT FILL

(71) Applicant: SIKA TECHNOLOGY AG, Baar (CH)

(72) Inventors: Sascha WIELING, Rosendahl (DE); Jens FISCHEDICK, Rosendahl (DE); Philipp SCHRÖDER, Billerbeck (DE); Nick SCHNEIDER, Billerbeck (DE)

(73) Assignee: SIKA TECHNOLOGY AG, Baar (CH)

(21) Appl. No.: 18/729,557

(22) PCT Filed: Jan. 16, 2023
(86) PCT No.: PCT/EP2023/050833

§ 371 Date: Jul. 17, 2024

(30) Foreign Application Priority Data
Feb. 4, 2022 (EP) 22155255.7

(51) Int. Cl. C04B 28/16; C04B 111/62

(52) U.S. Cl. CPC C04B 28/16; C04B 2111/62

(57) ABSTRACT

A single- or two-component mortar composition including i) an aluminate binder, ii) a calcium sulfate binder, iii) one or more fillers with a raw density of at least 2.0 g/cm3, and iv) one or more lightweight fillers with a raw density of less than 1.5 g/cm3, wherein the quantity of lightweight filler equals 30 to 70 wt. %, the total quantity of aluminate binder and calcium sulfate binder equals 20 to 65 wt %, and the weight ratio of aluminate binder to calcium sulfate binder ranges from 1:1 to 1:10. When used, the mortar composition hardens quickly and is suitable as a lightweight fill for producing floor structures on substrates with a limited load-bearing capacity.

### TECHNICAL FIELD

The present invention relates to a calcium sulfate-based mortar composition suitable for a lightweight fill and to a floor construction comprising such a lightweight fill.

### PRIOR ART

Floor constructions are often based on cement-bound screeds, which are applied to the existing subfloor. The practitioner may be confronted with a subfloor substrate which has a relatively low load-bearing capacity, e.g. during flooring renovation.

Conventional screeds generally have a relatively high intrinsic weight, and so cannot be used on bases with critical load-bearing capacity. In this case, lightweight fills are used, their weight being reduced by the use of lightweight fillers such as styrofoam.

The drying of such cement-bound systems takes a relatively long time, and so laying readiness is reached only after a prolonged time.

Floor constructions based on lightweight fills additionally have a relatively complex structure, and generally require the installation of a reinforcement layer and a further leveling screed layer in addition to the lightweight coating, before a final floor covering such as tiles can be applied. Therefore, several working steps are required.

The following problems therefore exist with the common floor constructions of the prior art that are based on cement-bound lightweight fills:
limitations on the way of working, e.g. time restrictions for the next working step or space restrictions
short pot life
long waiting time for walk-on stability
long curing time for initial strength (sufficient bending and compressive strength)
long drying time
the application of the final layer depends on the drying time of the floor construction-different times for different floor coverings (e.g. tiles, PVC, parquet)
long waiting time for the next working step or the application of the floor covering
many different working steps, for example additional priming
not fire-resistant, as fillers are polymer-based (additional protective construction may be required)

So-called binary and ternary binders are increasingly used for the formulation of building materials, e.g. for mortar compositions that can be used as screeds. Binary binders comprise aluminate cement and calcium sulfate as hydraulic binders. Ternary binders additionally comprise Portland cement as a third hydraulic binder. Binary and ternary binders have the advantage of shortening the time to laying readiness compared to standard cements.

For example, WO 2015/150319 A1 concerns quick-drying plaster compositions based on calcium aluminate and calcium sulfate as hydraulic binders.

### SUMMARY OF THE INVENTION

An object of the present invention is to provide a mortar composition for lightweight fills which cures quickly and is suitable for producing floor constructions on substrates with relatively low load-bearing capacity. In particular, the mortar composition is also intended to enable acceleration in the production of floor constructions on substrates or subfloors whose load capacity is limited. In addition, the system shall display good mechanical properties and also attain them quickly.

The inventors have found that this object can be achieved by using a mortar composition based on aluminate cement and calcium sulfate, to which large amounts of a lightweight filler, more particularly an inorganic lightweight filler, are added.

The invention therefore relates to a one- or two-component mortar composition comprising
i) an aluminate binder selected from calcium aluminate cement and/or calcium sulfoaluminate cement,
ii) a calcium sulfate binder selected from calcium sulfate hemihydrate and/or calcium sulfate anhydrite,
iii) one or more fillers having a particle density of at least 2.0 g/cm³, and
iv) one or more lightweight fillers, more particularly inorganic lightweight fillers, having a particle density of less than 1.5 g/cm³,
wherein the amount of lightweight filler, more particularly inorganic lightweight filler, having a particle density of less than 1.5 g/cm³ is 30% to 70% by weight and the total amount of aluminate binder and calcium sulfate binder is 20% to 65% by weight, the weight ratio of aluminate binder to calcium sulfate binder being in the range from 1:1 to 1:10, the weight information being based on the dry weight of the mortar composition.

In this application, the dry weight of the mortar composition refers to the dry weight of the mortar composition as a whole, i.e., in the case of a two-component mortar composition, to the combined total weight of both components.

The mortar composition of the invention is quick-curing and is particularly suitable as a lightweight fill for the production of floor constructions on substrates with limited load-bearing capacity. The quick curing has advantages for the walk-on stability and the development of force by the screed and enables production with fewer working steps and faster working processes. In addition, the lightweight fillers used have a relatively high strength. On this basis, typical screed processing is very possible.

In particular, owing to the fast hydration process of the mortar composition of the invention mixed with water, the curing, development of strength, and the entire drying process are very quick. This is the prerequisite for a shorter waiting time for the next working step and the eventual utilization of the floor construction.

With the mortar composition of the invention, the next working step (final troweling of the floor, i.e., final leveling) is possible after just a few hours of waiting time and not only after more than a day, as in the case of the systems according to the prior art.

It may be advantageous to use inorganic lightweight fillers which, in contrast to the organic polymer-based materials typically used, are fire-resistant.

In summary, the following advantages of the mortar composition of the invention or of the mortar composition mixed with water and applied to a substrate (screed) can be stated:
walk-on stability after a few hours
quick-drying properties
high and rapid development of force
low density
low pH (due to the gypsum-based technology)
reduction in work time
only one day of work for the floor renovation and the leveling of the final floor construction
resistance to fire through the use of mineral material and inorganic lightweight fillers, especially expanded glass

For the floor construction of the invention as a whole, which will be explained in detail later, there are further advantages:
ready for the final floor covering (tiles, PVC or parquet) after less than 48 hours from the start of the work
reduction of working steps, no primer required (use of materials based on the same base formula)
high maximum loads are possible, so construction is suitable for residential and commercial applications
very low surface weight
low installation height
any desired layer thicknesses
low deformation under load

### Ways of Executing the Invention

The invention relates to a one- or two-component mortar composition. In a one-component mortar composition, all of the ingredients are united in one component, while in a two-component mortar composition, the ingredients are distributed over two components. In a two-component mortar composition of the invention, it is preferred that one component contains or is formed of the one or more lightweight fillers, while the other component contains the other ingredients of the mortar composition. In a two-component mortar composition, the component containing the binder is preferably mixed with water before the component containing the lightweight filler is mixed in.

The one-component mortar composition is preferably a dry mortar. Accordingly, the component of the two-component mortar composition that does not contain the one or more lightweight fillers is preferably a dry mortar.

The one- or two-component mortar composition of the invention comprises
i) an aluminate binder selected from calcium aluminate cement and/or calcium sulfoaluminate cement,
ii) a calcium sulfate binder selected from calcium sulfate hemihydrate and/or calcium sulfate anhydrite,
iii) one or more fillers having a particle density of at least 2.0 g/cm³, and
iv) one or more lightweight fillers, more particularly inorganic lightweight fillers, having a particle density of less than 1.5 g/cm³.

The aluminate binder is calcium aluminate cement and/or calcium sulfoaluminate cement. The aluminate binder is preferably calcium sulfoaluminate cement. The aluminate binder is a hydraulic binder.

In one embodiment, the aluminate binder comprises at least one calcium aluminate cement (CAC). A calcium aluminate cement (CAC) according to the present invention is in particular a cement comprising a clinker which comprises hydraulic calcium aluminates, the main phase being preferably CA (C: CaO; A: Al₂O₃). Other calcium aluminates, such as C₂A, C₃A, and C₁₂A₇, for example, are typically likewise present. CACs for the present invention may typically also contain other phases, selected from gehlenite (C₂AS with C: CaO, A: Al₂O₃, S: SiO₂), perovskite (CT with C: CaO, T: TiO₂), belite (C₂S with C: CaO, S: SiO₂), tricalcium silicate, ferrites (C₂F, C₂AF, C₄AF with C: CaO; A: Al₂O₃; F: Fe₂O₃), ternesite (C₅S₂$ with C: CaO, S: SiO₂; $: SO₃) and aluminum oxide. CACs of the present invention may additionally contain calcium carbonate. In particular, a CAC of the present invention conforms to the standard EN 14647. Equally suitable are CACs described in other standards, e.g., ASTM or Chinese standards. Suitable CACs may be obtained commercially for example from Royal White Cement.

According to one embodiment, the aluminate binder contains at least one calcium sulfoaluminate (CSA) cement. According to the present invention, a CSA cement is, in particular, a cement comprising a clinker which comprises C₄(A₃₋ₓFₓ) $ (C: CaO; A: Al₂O₃; F: Fe₂O₃; $: SO₃), where x is an integer 0-3. CSAs for the present invention may typically contain further phases, selected from aluminates (CA, C₃A, C₁₂A₇, with C: CaO; A: Al₂O₃), belite (C₂S, with C: CaO, S: SiO₂), ferrites (C₂F, C₂AF, C₄AF, with C: CaO; A: Al₂O₃, F: Fe₂O₃), ternesite (C₅S₂$ with C: CaO, S: SiO₂; $: SO₃) and anhydrite. In certain embodiments of the invention, the CSA contains 15-75% by weight C₄A₃$, 0-10% by weight aluminates, 0-70% by weight belite, 0-35% by weight ferrites, 0-20% by weight ternesite, and
0-25% by weight anhydrite, based in each case on the total dry weight of the CSA cement. Any anhydrite present is part of the CSA cement and is to be included therein. Suitable CSAs may be obtained for example under the trade name Calumex from Caltra B.V.

The calcium sulfate binder is a hydraulic binder. The calcium sulfate binder is selected from calcium sulfate hemihydrate (CaSO₄·½ H₂O) and/or calcium sulfate anhydrite (CaSO₄), with calcium sulfate hemihydrate being preferred. Calcium sulfate anhydrite is anhydrous calcium sulfate (no water of crystallization). Calcium sulfate hemihydrate comprises alpha-calcium sulfate hemihydrate and beta-calcium sulfate hemihydrate, with calcium sulfate hemihydrate being preferred.

In relation to the calcium sulfate binder, it is preferred for it to consist substantially or completely of calcium sulfate hemihydrate, since too high a proportion of anhydrite results in excessively rapid uptake of water by the anhydrite constituent, which may affect the workability of the composition. As a result, it is preferred if at least 80% by weight of the total amount of calcium sulfate binder, preferably at least 90% by weight, and particularly preferably at least 95% by weight, is accounted for by the calcium sulfate hemihydrate (balance: calcium sulfate anhydrite).

Calcium sulfate dihydrate (CaSO₄·2 H₂O) is incapable of binding water and so is not included here within the calcium sulfate binder. However, the mortar composition may optionally also contain calcium sulfate dihydrate. Calcium sulfate dihydrate can serve as a so-called nucleating agent and causes a faster reaction of the calcium sulfate hemihydrate. The mortar composition therefore preferably comprises calcium sulfate dihydrate.

The mortar composition of the invention also contains one or more lightweight fillers having a particle density of less than 1.5 g/cm³. The lightweight fillers are preferably made of an inorganic material, e.g. glass, or of a mineral material, which generally contains pores or constitutes a hollow body.

Suitable lightweight fillers can, however, also be organic materials, more particularly recycled plastic, ground rubber or biobased lightweight fillers, in particular based on hemp, rice husks, wood or cork.

The particle density of a particle material such as fillers is the ratio between the mass of the particle material and the volume taken up by the individual particles. This volume includes the pores within the particles (internal pore volume), but not the cavities between the particles. In contrast to the bulk density, therefore, the particle density disregards the interstices between the particles of the material. The particle densities specified in this application relate to a temperature of 20° C. The particle density can be determined in accordance with the standard EN 1097-6-2013.

The one or more lightweight fillers, e.g. the following examples, in particular expanded glass, have a particle density of less than 1.5 g/cm³, preferably less than 1.0 g/cm³, more preferably less than 0.6 g/cm³, particularly preferably less than 0.5 g/cm³. In general, the particle density is preferably at least 0.05 g/cm³, more preferably at least 0.1 g/cm³.

Examples of suitable inorganic lightweight fillers having the abovementioned particle densities are selected from expanded glass, hollow glass spheres, foam glass ballast, hollow aluminum silicate spheres, pumice, expanded clay, expanded shale, expanded perlite, recycled aggregate, e.g. from lightweight concrete or aerated concrete, non-expanded perlites, hollow silicatic microspheres or combinations thereof, preferably expanded glass, pumice, expanded perlite, expanded clay, expanded shale or combinations thereof.

In one preferred embodiment, the one or more lightweight fillers having a particle density of less than 1.5 g/cm³ are expanded glass.

The one or more lightweight fillers, e.g. the above-stated examples, more particularly inorganic lightweight fillers, preferably expanded glass, preferably have a mean grain size in the range from 0.05 to 16 mm, preferably 0.5 to 10 mm, more preferably 1 to 7 mm, particularly preferably 2 to 4 mm. This applies to all of the above-stated particle densities and preferred particle densities.

The terms grain size and particle size or particulate size are used synonymously here. The grain size or particle size here refers to the mean grain size or particle size, unless otherwise specified. The mean grain size corresponds in particular to the D50 value (50% of the particles are smaller than the specified value, 50% are correspondingly larger).

The particle size of fine particles with a particle size of up to 3.5 mm can be measured by laser diffraction as described in ISO 13320:2009. In particular, a Mastersizer 2000 instrument with a Hydro 2000G dispersing unit and the Mastersizer 2000 software from Malvern Instruments GmbH (Germany) are used. Isopropanol, for example, is a suitable measuring medium. Preferably, the particle size of non-spherical or irregular particles is represented by the equivalent sphere diameter of a sphere having the same volume.

The particle size of coarse particles with a particle size greater than 3.5 mm can be determined by sieve analysis, as described, for example, in the ASTM C136/C136M standard. In this process, particles of different sizes are separated by sieving the material through a series of sieves with different mesh sizes. The material for analysis is shaken with a single motion or a combination of horizontal, vertical or rotating motion through a series of successively decreasing sieves. The result is the percentage fraction of the particles that pass through a sieve of a certain size. In principle, sieve analysis is also suitable for determining the particle size of particles below 3.5 mm.

Sieve grades consisting of two or more lightweight fillers, more particularly inorganic lightweight fillers, having a particle density of less than 1.5 g/cm³ with different particle size distributions may also be used, and the lightweight fillers may be of the same or different type. Such mixtures can be used to influence properties including the strength of the mortar composition, and other properties that derive from the processing.

The lightweight fillers, more particularly inorganic lightweight fillers, having a particle density of less than 1.5 g/cm³ preferably meet the requirements for lightweight fillers according to DIN EN 13055:2016.

The particles of the lightweight fillers, more particularly inorganic lightweight fillers, having a particle density of less than 1.5 g/cm³ may have any desired spherical and/or non-spherical geometric shape, either uniform or non-uniform. The particles may for example be spherical, conical, polygonal, cubic, pentagonal, hexagonal, octagonal, prismatic and/or polyhedral in shape. Non-uniform particles may for example have circular, elliptical, oval, square, rectangular, triangular or polygonal cross sections, which are at least partially in them. “Non-uniform” and “irregularly” shaped particles refer to three-dimensional particle shapes in which at least two different cross sections through the particles have different shapes. The same applies to the geometric shape of the particles of the fillers described below and having a particle density of at least 2.0 g/cm³.

The mortar composition further contains one or more fillers having a particle density of at least 2.0 g/cm³, which are also referred to as aggregates, the particle density of the one or more fillers being preferably at least 2.2 g/cm³.

Fillers having a particle density of at least 2.0 g/cm³, preferably at least 2.2 g/cm³, that may be used are those substances known to the person skilled in the art in the field. Examples are rock, ballast, gravel, slag, ground rock, recycled aggregate, recycled concrete, sand, such as quartz sand or river sand, ground rock, glass, glass-ceramic, porcelain, electrofused or sintered abrasives, firing aids, silicon dioxide, carbonates, such as ground limestone, ground dolomite and chalk, and/or ground aluminum oxide.

It is possible to use solid materials for which opportunities for (re) utilization are being sought. Examples of such fillers or aggregates having a particle density of at least 2.0 g/cm³ are the following, provided that they have a particle density of at least 2.0 g/cm³.

(i) materials of biological origin, preferably plant origin, especially materials of plant origin consisting substantially of cellulose and/or lignin.

(ii) inorganic aggregates from the dismantling of civil engineering structures, preferably selected from concrete wastes, mortar, brick, natural stone, asphalt, flag tiles, glazed tiles, clinker, metal scrap.

(iii) granular materials normally intended for landfill which are not harmful to health, such as used foundry sands, catalyst supports, clinker aggregates, fillers from the treatment of excavated sludge, sewage sludge, slurry, paper wastes, paper incineration ash, domestic waste incineration ash.

In one preferred embodiment, the one or more fillers having a particle density of at least 2.0 g/cm³ comprise or are sand and/or carbonate, in particular in the form of calcium carbonate. Suitable sands are described for example in the standards ASTM C778 or EN 196-1. Calcium carbonate also includes limestone, or limestone flour, and chalk. The sand may in particular be quartz sand or river sand.

A suitable quartz sand has a grading curve for example within a range from about 0 to 0.5 mm, preferably within a range from about 0.08 to 0.4 mm. A further suitable quartz sand has a particle size for example within a range from about 0.1 to 1 mm, preferably from about 0.2 to 0.8 mm.

A suitable calcium carbonate has, for example, a mean particle diameter in the range of about 3 μm and a particle grade in residue-free form of about 40 μm. A suitable limestone flour has a fineness for example of <0.1 mm.

In the following text, weight information relating to the one- or two-component mortar composition of the invention relate to the dry weight of the mortar composition as a whole, unless otherwise indicated.

The total amount of aluminate binder and calcium sulfate binder in the mortar composition of the invention is 20% to 65% by weight, preferably 20% to 60% by weight, more preferably 35% to 55% by weight, based on the dry weight of the mortar composition.

The weight ratio of aluminate binder to calcium sulfate binder in the mortar composition is in the range from 1:1 to 1:10, preferably in the range from 1:1 to 1:5, more preferably 1:1 to 1:3.5.

The content of lightweight filler, more particularly inorganic lightweight filler, having a particle density of less than 1.5 g/cm³, preferably having a particle density of less than 1.0 g/cm³, based on the dry weight of the mortar composition, is 30% to 70% by weight, preferably 35% to 65% by weight, more preferably 40% to 60% by weight.

The content of filler having a particle density of at least 2.0 g/cm³, preferably at least 2.2 g/cm³, based on the dry weight of the mortar composition, can be, for example, 2% to 20% by weight, preferably 4% to 15% by weight, based on the dry weight of the mortar composition.

In one preferred embodiment, the mortar composition of the invention comprises:
i) 8% to 20% by weight of the aluminate binder,
ii) 20% to 50% by weight of the calcium sulfate binder and
iii) 35% to 65% by weight of the one or more inorganic lightweight fillers having a particle density of less than 1.5 g/cm³, preferably less than 1.0 g/cm³.

In one preferred embodiment, the mortar composition may further comprise at least one lithium salt, which accelerates the curing of the composition. Suitable lithium salts are, for example, lithium sulfate and lithium halides, especially lithium chloride, and also lithium carbonate. The most preferred is lithium carbonate.

The lithium salt, in particular lithium carbonate or lithium sulfate, is preferably contained in an amount of 0.001% to 0.5% by weight, more preferably 0.003% to 0.05% by weight, in the mortar composition. At less than 0.001%, the concentration is generally too low to impart a noticeably accelerating effect, while an addition of more than 0.5% by weight can lead to excessively quick curing of the composition and/or shows no additional effect at all and the additive acts more as a filler.

In one preferred embodiment, the mortar composition may also contain tartaric acid and/or a tartaric acid salt, preferably an alkali metal salt of tartaric acid, preferably in an amount of 0.15% to 0.005% by weight, more preferably 0.1% to 0.01% by weight. Preference is given to sodium or potassium tartrate or to the mixed salt sodium/potassium tartrate.

The addition of tartaric acid and/or a tartaric acid salt has a positive effect on the expansion behavior of the mortar composition, by allowing excessive expansion of the material to be suppressed. To achieve such an effect, at least 0.005% by weight is generally used, while more than 0.15% by weight can lead to excessively severe retardation of setting.

Other suitable retarders that can be added alternatively or in addition to the tartaric acid and/or the tartaric acid salt are gluconates, in particular sodium gluconate, or citric acid and/or a citric acid salt, e.g. sodium citrate.

In one preferred embodiment, the mortar composition may also contain at least one plasticizer. The plasticizers customary in the field can be used. Particularly suitable plasticizers are polycarboxylate ethers (PCE), which are also referred to as “superplasticizers”. The polycarboxylate ether preferably has polyethylene glycol side chains.

The content of plasticizer, more particularly polycarboxylate ether, in the mortar composition is preferably in the range from 0.005% to 0.5% by weight, more preferably 0.01% to 0.1% by weight.

The mortar composition of the invention may thus, in one preferred embodiment, also comprise at least one additive selected from a lithium salt, at least one retarder selected from one of tartaric acid or a tartaric acid salt, a gluconate, in particular sodium gluconate, and citric acid or a citric acid salt, a plasticizer, the plasticizer being preferably a polycarboxylate ether, or a combination thereof. These additives are described above. In one particularly preferred embodiment, the mortar composition comprises a lithium salt, tartaric acid or a tartaric acid salt and a plasticizer, preferably a polycarboxylate ether. In addition to the additives stated, the mortar composition may also contain one or more other additives, e.g. thickening agents, dyes and/or color pigments, curing retarders, stabilizing agents, defoamers, shrinkage reducers and/or flexibilizing agents.

Examples of suitable flexibilizing agents are organic polymers, e.g. based on vinyl acetate and ethylene, which are available, for example, as Vinnapas®5025 L from Wacker. A suitable retarder is available for example under the trade name Retardan® P from Sika Schweiz AG. Examples of suitable color pigments are inorganic or organic pigments, such as metal oxides and mixed metal oxides, e.g. iron oxides.

Examples of shrinkage reducers are polyols with 2 to 4 hydroxyl groups, preferably glycerol and/or erythritol. It has been found that the use of at least one aforementioned polyol can lead to a particularly large reduction in shrinkage.

The mortar composition may also contain Portland cement, but this is generally not preferred. The mortar composition may, for example, contain up to 5% by weight, preferably not more than 3% by weight, more preferably not more than 1% by weight, in particular not more than about 0.1% by weight of Portland cement. However, the mortar composition is preferably free from Portland cement.

The quantities of the individual constituents in the mortar composition may also depend on the type of application and the applied layer thickness.

One advantageous embodiment of the mortar composition of the invention contains
8% to 20% by weight of the aluminate binder,
20% to 50% by weight of the calcium sulfate binder,
35% to 65% by weight of the one or more inorganic lightweight fillers having a particle density of less than 1.5 g/cm³, preferably less than 1.0 g/cm³, more particularly expanded glass,
4% to 15% by weight of filler having a particle density of at least 2.0 g/cm³, preferably at least 2.2 g/cm³, more particularly sand, e.g. quartz sand, and/or calcium carbonate, e.g. chalk and/or limestone,
0.01% to 0.10% by weight of tartaric acid salt, more particularly potassium sodium tartrate,
0.003% to 0.5% by weight of lithium salt, especially lithium carbonate or lithium sulfate.

The invention further relates to a method for producing a floor construction on a substrate, comprising
a) applying a mixture of the mortar composition of the invention, as described above, with water to the substrate, to form a first screed layer,
b) applying a reinforcement layer to the first screed layer,
c) applying a mixture of a leveling compound with water to the reinforcement layer, to form a second screed layer, and
d) optionally applying a floor covering to the second screed layer.

The above information with regard to the mortar composition of the invention applies in the same way with regard to the method of the invention.

The method of the invention relates to the production of a floor construction on a substrate or a base. The substrate is not subject to any restrictions. The method of the invention, owing to the mortar composition of the invention used, with which a lightweight fill can be obtained, is suitable in particular for substrates with a limited load-bearing capacity. The method of the invention is particularly suitable, e.g., for floor renovations.

Examples of suitable substrates are substrates made of wood, concrete, screeds, old substrates with ceramic coverings, old substrates based on screeds or concrete. The substrate may be, for example, a substrate based on cement, such as Portland cement, or on calcium sulfate. The substrate is preferably a wood substrate or it is a multi-layer substrate comprising a wood layer, e.g. a subfloor made of wood with an old substrate on it.

The substrate can optionally be provided with one or more primers before application of the mortar composition mixed with water according to step a). The primer here is applied to the substrate, e.g. by spreading. Pretreatment of this kind is known to the person skilled in the art. Common primers can be used, e.g. polymeric dispersions or two-component primers based on organic binders, e.g. epoxy resin binders. Primer-fillers are also suitable as the primer, for priming and filling in one operation. Alternatively, the substrate can be provided with a separating layer, e.g. a PE film, if the screed is to be laid as a floating screed.

In the method of the invention, the mortar composition of the invention is mixed with water in step a). As the mortar composition contains hydraulic binders in the form of aluminate binder and calcium sulfate binder, hydration reactions take place, as is known, after the addition of water. By drying or setting, over time the mortar composition cures. Application to the optionally primed substrate takes place when the mortar composition is still fluid or pasty.

The mixing of the two-component mortar composition of the invention from a component A comprising the lightweight filler and a component B comprising the remaining components of the mortar composition can be carried out, for example, in the following manner. Component B is mixed with water, e.g. for around 60 seconds. Suitable mixing ratios of mortar composition (including lightweight filler) and water are given below. Cold, clean water should appropriately be used. With the stirring mechanism running, component A (lightweight filler) is added to the homogeneous mixture obtained and stirring is continued for some time, e.g. around 120 seconds, to obtain the ready-to-use mixture. It is also possible to tip component B, mixed with water, over component A (lightweight filler) and then to mix this mixture again.

The consistency or rheological behavior of the mortar composition can be adjusted not only by the choice of additives used but also, in particular, by the mixing ratio of mortar composition and water. It is preferred to mix the mortar composition with water in a mass ratio of water to mortar composition in the range from 0.08 to 0.50, preferably 0.10 to 0.40, in particular 0.20 to 0.35. The mortar composition obtained is advantageously pumpable, which facilitates transport.

The mortar composition mixed with water is then applied to the substrate, which has been optionally provided with a primer or a separating layer. The application can be done by any means known to the person skilled in the art, e.g., by means of a trowel, rake, doctor or roller, by casting or by means of squirting or spraying processes, preferably by means of a trowel, doctor, casting or rake. After application, the applied mortar composition can be optionally smoothed, e.g. with a trowel. As a rule, the applied material is drawn off over inserted gauges and then smoothed or “compacted” using a trowel.

After application of the mortar composition, it is general practice to wait until the first layer has walk-on stability before applying the reinforcing fabric. The first screed layer is more particularly a lightweight fill.

Reinforcement layers employed may be the reinforcements usually used in the field. The reinforcement layer is or comprises preferably a sheetlike textile carrier, e.g. a woven fabric, a nonwoven or a laid scrim. Preference is given to systems other than a nonwoven, so that the first screed layer and the leveling layer (second screed layer) can interlock with each other. Multi- or three-dimensional woven fabrics or laid scrims, in particular made of glass fibers, are also conceivable. The reinforcement layer is or comprises preferably an armored fabric.

The reinforcement layer is or comprises particularly preferably a sheetlike textile carrier made of glass fiber, e.g. as a woven fabric, a nonwoven or a laid scrim, in particular a woven glass fiber fabric or laid glass fiber scrim. The glass fibers can be plastic-coated. The sheetlike textile carrier, e.g. as a woven fabric, a nonwoven or a laid scrim, may also be formed of another fiber material, e.g. of polymer fibers.

The reinforcement layer is preferably fixed on the first screed layer, e.g. mechanically by means of a clamp and/or with a reinforcing mortar. Calcium sulfate filling compounds based on calcium sulfate binders are particularly suitable as reinforcing mortars. The calcium sulfate binder of the calcium sulfate filling compound is in particular selected from calcium sulfate hemihydrate and/or calcium sulfate anhydrite corresponding to the calcium sulfate binder of the mortar composition of the invention. Preferably, a sag-resistant filling compound, in particular a sag-resistant calcium sulfate filling compound, is to be used. Also conceivable is a filling compound which comprises calcium sulfate binder and aluminate binder as binders, the definition of these binders having been described for the mortar composition of the invention.

An advantage of the method of the invention is that the mortar composition of the invention in the first screed layer dries quickly, so that after a relatively short drying period, e.g. less than 6 hours', preferably less than 4 hours', especially preferably after no more than 2 hours' waiting time according to step b), the reinforcing fabric can be attached and it is then possible to continue with step c), the application of the second screed layer, after just another short waiting time, e.g. of around 30 min.

According to step c) of the method of the invention, a mixture of a leveling compound with water is applied to the reinforcement layer, to form a second screed layer. The usual application methods can be used. Examples are given above for the first screed layer. The leveling compound can be self-leveling or, optionally, can be smoothed, e.g. with a trowel.

Quick-curing systems are used in particular as the leveling compound. The leveling compound is preferably a calcium sulfate filling compound, comprising a calcium sulfate binder, where the calcium sulfate filling compound preferably comprises a calcium sulfate binder and an aluminate binder. The use of such calcium sulfate filling compounds is preferred, because on the one hand fast drying takes place and on the other hand a prior priming on the first screed layer produced is not necessary, which makes the method particularly economical and simple.

The calcium sulfate binder of the calcium sulfate filling compound is in particular selected from calcium sulfate hemihydrate and/or calcium sulfate anhydrite, corresponding to the calcium sulfate binder of the mortar composition of the invention, to which reference is made. The aluminate binder of the calcium sulfate filling compound, where present, is in particular selected from calcium aluminate cement and/or calcium sulfoaluminate cement, corresponding to the aluminate binder of the mortar composition of the invention, to which reference is made. The calcium sulfate filling compound used as a leveling compound generally contains no lightweight fillers having a particle density of less than 1.5 g/cm³, but instead a higher proportion of customary fillers, e.g. sand and/or calcium carbonate.

An advantage of the floor construction which is formed of the first screed layer of the lightweight fill of the invention, the reinforcement layer and the second screed layer, is the rapid curing, so that no later than 48 hours after application of the second screed layer, preferably after application of the first layer, laying readiness is reached. This refers to continuous working, taking into account the necessary waiting times for drying. It is understood that the duration may be extended, taking account of working hours and the practical process.

After laying readiness has been reached, a floor covering can optionally and preferably be applied to the second screed layer. Customary floor coverings can be applied. Examples of floor coverings are tiles, laminate, PVC (polyvinyl chloride), linoleum or carpet. The floors can be fixed on the second screed layer in a usual way, e.g. by adhesive bonding.

The layer thicknesses of the screed layers are not limited in principle. In the following information, the layer thicknesses refer to the dried layer.

The first screed layer may, for example, have a layer thickness of at least 15 mm, with the first screed layer preferably having a layer thickness in the range from 15 to 100 mm, more preferably 20 to 100 mm. The layer thickness can also depend on whether the screed is laid as a bonded screed or floating screed. When laid as a bonded screed, the layer thickness is preferably at least 15 mm, while when laid as a floating screed, the layer thickness is preferably at least 25 mm.

The second screed layer may, for example, have a layer thickness of at least 6 mm, with the second screed layer preferably having a layer thickness in the range from 6 to 50 mm, more preferably 6 to 10 mm.

One preferred embodiment of the method of the invention for a floor construction with a bonded screed comprises
dispersion primer or filling primer on underfloor construction, in particular a wood substrate, e.g. wooden floorboards,
application of the mortar composition of the invention as the first screed layer (lightweight fill)—preferred layer thickness between 15 and 100 mm, drying time for applying the reinforcement layer less than 6 hours, e.g. after just 2 hours (corresponds to time until the first screed layer has walk-on stability),
application of armored fabric or glass fiber fabric, fixed with calcium sulfate filling compound (e.g. sag-resistant calcium sulfate filling compound),
application of calcium sulfate filling compound as a leveling compound for a second screed layer (e.g. quick-curing fine-filling compound)—preferred layer thickness between 6 and 50 mm, but especially between 6 and 10 mm; ready for the final floor covering at the latest after 48 hours

One preferred embodiment of the inventive method for a floor construction with a floating screed comprises
application of PE film 100 μm on underfloor construction (PE=polyethylene),
application of the mortar composition of the invention as the first screed layer (lightweight fill)—preferred layer thickness between 25 and 100 mm, drying time for applying the reinforcement layer less than 6 hours, e.g. after just 2 hours,
application of armored fabric or glass fiber fabric (e.g. Schönox® PZG), fixed with calcium sulfate filling compound (e.g. sag-resistant calcium sulfate filling compound),
application of calcium sulfate filling compound as a leveling compound for a second screed layer (e.g. quick-curing fine-filling compound)—preferred layer thickness between 6 and 50 mm, but especially between 6 and 10 mm; ready for the final floor covering at the latest after 48 hours

The floor construction of the invention is preferably a flooring construction, especially for the interior sector. The floor construction is particularly suitable for floors of living rooms or sales areas of retail outlets or else for the commercial sector.

Owing to the low weight of the floor construction of the invention, it is particularly suitable for subfloor constructions or substrates with low load-bearing capacity. Preferred fields of application are floor renovation and/or floor construction on wood substrates or substrates comprising layers of wood.

The invention also relates to the use of the one- or two-component mortar composition of the invention as described above as a screed, more particularly as a lightweight fill.

The above information with regard to the mortar composition of the invention and the method of the invention apply in the same way with regard to the use according to the invention, in particular with regard to the design of the mortar composition, the floor construction and the substrate, and so reference is made thereto.

The use according to the invention is preferably suitable for producing a floor construction on a substrate, comprising in this order a first screed layer of the one- or two-component mortar composition of the invention, a reinforcement layer and a second screed layer, where optionally a floor covering is arranged over the second screed layer.

The use according to the invention is preferably suitable for flooring renovation or floor renovation, because here the weight of filling compounds or screeds is often limited owing to the load-bearing capacity of the subfloor construction.

The use according to the invention is preferably suitable for a subfloor construction composed of a wood substrate or a multi-layer substrate comprising a wood layer.

The use according to the invention is particularly suitable in the context of a floor construction of the invention as described below.

The invention also relates to a floor construction on a substrate, comprising, in this order, a first screed layer of the mortar composition of the invention as described above, a reinforcement layer and a second screed layer, where optionally a floor covering is arranged over the second screed layer.

The above information with regard to the mortar composition of the invention, the method of the invention and the use according to the invention apply in the same way with regard to the floor construction of the invention, in particular with regard to the design of the mortar composition, the reinforcement layer, the first and second screed layers, the floor covering and the substrate, and so reference is made thereto.

The floor construction is preferably obtainable by a method of the invention as described above.

The invention is elucidated in more detail hereinbelow with reference to exemplary embodiments. The examples are provided by way of illustration and are not intended to limit the present invention in any way.

### WORKING EXAMPLES

### Example 1

### Mortar Composition

A two-component mortar composition was produced from the components A and B according to the following formulations.

Component A

| | | Parts by |
|---|---|---|
| | | weight |
| Calcium sulfoaluminate (i.tech ALI CEM | Binder | 23.78 |
| GREEN) | | |
| alpha-Calcium sulfate hemihydrate | Binder | 61.846 |
| CaCO₃, grain size: D50: 2.2 μm | Filler | 12.282 |
| Calcium sulfate dihydrate | | 1.307 |
| Vinyl acetate-ethylene copolymer, | Redispersible | 0.5 |
| 98% solids, minimum film-forming | powder | |
| temperature 4° C. (DIN ISO 2115) | | |
| Lithium carbonate | Accelerator | 0.014 |
| Potassium sodium tartrate | Retarder | 0.105 |
| Sodium gluconate powder | Retarder | 0.116 |
| Polycarboxylate ether with polyethylene | Plasticizer | 0.05 |
| glycol side chains | | |
| Total | | 100 |

Component B

| | |
|---|---|
| Expanded glass, grain size 2-4 mm, | 100 |
| particle density: about 0.32 g/cm³ | |

Component A and component B were mixed in a ratio of 50% by weight of component A and 50% by weight of component B. The mortar composition obtained had the following composition.

Mortar composition

| | | Parts by |
|---|---|---|
| | | weight |
| Calcium sulfoaluminate (i.tech ALI CEM | Binder | 11.89 |
| GREEN) | | |
| alpha-Calcium sulfate hemihydrate | Binder | 30.922 |
| CaCO₃, grain size: D50: 2.2 μm | Filler | 6.141 |
| Calcium sulfate dihydrate | | 0.654 |
| Vinyl acetate-ethylene copolymer, | Redispersible | 0.25 |
| 98% solids, minimum film-forming | powder | |
| temperature 4° C. (DIN ISO 2115) | | |
| Lithium carbonate | Accelerator | 0.007 |
| Potassium sodium tartrate | Retarder | 0.053 |
| Sodium gluconate powder | Retarder | 0.058 |
| Polycarboxylate ether with polyethylene | Plasticizer | 0.025 |
| glycol side chains | | |
| Expanded glass, grain size 2-4 mm, | | 50 |
| particle density: about 0.32 g/cm³ | | |
| Total | | 100 |

### Example 2 and Comparative Example 1

With the mortar composition of Example 1, a floor construction was produced on a plasterboard as substrate (alternatively a concrete substrate) in the following manner (Example 2):
mixing mortar composition of Example 1 with water (ratio 100 kg mortar composition/16.4 l water)
applying the mixture to the substrate in the layer thickness specified in Table 1
placing on an armored fabric (woven glass fiber fabric) about 2 hours after applying the mixture and fixing with calcium sulfate filling compound
applying a leveling compound (calcium sulfate filling compound) to the fabric after around 2 hours, layer thickness around 8 mm

Using a commercially available cement-based dry mortar for lightweight fills (containing lightweight expanded polystyrene aggregate), a floor construction was produced on a gypsum board as substrate in the following manner

### Comparative Example 1

mixing dry mortar with water (ratio 100 kg dry mortar/47.6-52.4 l water)
applying the mixture to the substrate in the layer thickness specified in Table 1
placing on a glass fiber nonwoven about 4 hours after applying the mixture
applying a cementitious thin coat to the nonwoven after around 48 hours, layer thickness around 8 mm

The properties of the floor constructions according to Example 2 and Comparative Example 1 were tested. The results are shown in Table 1. The tests were carried out on the mortar composition of the invention (“Fill” in Table 1) or on the entire floor construction (“System” in Table 1).

The following test methods were used:
Particle density: in accordance with DIN EN 1015-10
Flexural tensile strength/Compressive strength: in accordance with DIN EN 13892-2
Chair roll tester: in accordance with ASTM C627
Adhesive tensile strength: in accordance with DIN EN 13892-8
Pot life 2:20 min after mixing of the mortar composition of Example 2 or the dry mortar of Comparative Example 1 with water, a small area was produced with the mixture every 5 min and tested the next day with a hammer blow. When surface crumbles: end of pot life (end of PL)

TABLE 1

| | | | | | | | |
|---|---|---|---|---|---|---|---|
| | | | | Layer | | Comparative | |
| Test method | Storage | Fill | System | thickness | Example 2 | example 1 | Unit |

Pot life

| | |
|---|---|
| 45 min | >240 min |

Drying

| | | | | | | | |
|---|---|---|---|---|---|---|---|
| Dry moisture 40° C. | 2 h | x | | 20 mm | 7.7 | still fresh | % |
| | 6 h | x | | | 4.1 | 23.25 | % |
| | 1 d | x | | | 0.75 | 13.6 | % |
| | 2 d | x | | | 0.6 | 5.8 | % |
| | 2 h | x | | 100 mm | 7.62 | still fresh | % |
| | 6 h | x | | | 5.92 | 29.14 | % |
| | 1 d | x | | | 4.82 | 22.14 | % |
| | 2 d | x | | | 4.38 | 18.42 | % |
| | 6 h | | x | 32 mm + 8 mm | 4.41 | 8.43 | % |
| | 1 d | | x | (prism) | 2.92 | 6.49 | % |
| | 7 d | | x | | 0.82 | 3.2 | % |

Particle density (determined on prism)

| | | | | | | |
|---|---|---|---|---|---|---|
| Particle density | 2 h | x | 40 mm | 0.41 | still soft | kg/dm³ |
| | 6 h | x | | 0.41 | still soft | kg/dm³ |
| | 1 d | x | | 0.41 | 0.35 | kg/dm³ |
| | 7 d | x | | 0.41 | 0.35 | kg/dm³ |
| | 28 d | x | | 0.41 | 0.35 | kg/dm³ |

Flexural tensile/compressive strengths

| | | | | | | | |
|---|---|---|---|---|---|---|---|
| FT/C prism | 2 h | x | | 40 mm | 0.22/0.89 | not measurable | N/mm² |
| | 6 h | x | | | 0.41/1.33 | not measurable | N/mm² |
| | 1 d | x | | | 0.59/1.81 | 0.15/0.28* | N/mm² |
| | 7 d | x | | | 0.74/1.93 | 0.40/0.38 | N/mm² |
| | 28 d | x | | | 0.71/1.90 | 0.43/0.42 | N/mm² |
| FT Prism | 6 h | | x | 40 mm | 1.2 | 0.4 | N/mm² |
| | 1 d | | x | | 1.2 | 0.5 | N/mm² |
| | 7 d | | x | | 1.3 | 0.7 | N/mm² |
| | 28 d | | x | | 1.5 | 0.7 | N/mm² |

Chair roll tester in accordance with ASTM C627

| | | | | |
|---|---|---|---|---|
| Chair roll tester | 2 d | x | 20 mm | System structures were resistant to the effect |
| | 7 d | x | | up to the last load class. The only difference |
| | 2 d | x | 100 mm | was that for Comparative Ex. 1, longer waiting |
| | 7 d | x | | times until loading had to be observed. |

Adhesive tensile strength

| | | | | | | |
|---|---|---|---|---|---|---|
| ATS drilled | 1 d | x | 20 mm + 8 mm | 0.38 border | 0.46 in the | N/mm² |
| | | | | fabric + in the | screed | |
| | | | | screed | | |
| ATS not drilled | 1 d | x | | 0.81 surface + | 0.93 border | N/mm² |
| | | | | in SpMa | nonwoven | |
| ATS drilled | 7 d | x | | 0.60 in the | 0.49 in the | N/mm² |
| | | | | screed | screed | |
| ATS not drilled | 7 d | x | | 1.10 surface + | 1.00 in | N/mm² |
| | | | | in SpMa | SpMa | |

Pot life 2

| | | | | | |
|---|---|---|---|---|---|
| End of PL | x | 20 mm | 45 | >130 | min |

*prisms too soft; SpMa = filling compound

1. A one- or two-component mortar composition comprising
i) an aluminate binder selected from calcium aluminate cement and/or calcium sulfoaluminate cement,
ii) a calcium sulfate binder selected from calcium sulfate hemihydrate and/or calcium sulfate anhydrite,
iii) one or more fillers having a particle density of at least 2.0 g/cm³, and
iv) one or more lightweight fillers, having a particle density of less than 1.5 g/cm³,
wherein the amount of lightweight filler, having a particle density of less than 1.5 g/cm³ is 30% to 70% by weight and the total amount of aluminate binder and calcium sulfate binder is 20% to 65% by weight, the weight ratio of aluminate binder to calcium sulfate binder being in the range from 1:1 to 1:10, the weight information being based on the dry weight of the mortar composition.

2. The one- or two-component mortar composition as claimed in claim 1, wherein the content of lightweight filler, having a particle density of less than 1.5 g/cm³ is 35% to 65% by weight, based on the dry weight of the mortar composition.

3. The one- or two-component mortar composition as claimed in claim 1, wherein the one or more lightweight fillers having a particle density of less than 1.5 g/cm³ are selected from expanded glass, hollow glass spheres, foam glass ballast, hollow aluminum silicate spheres, pumice, expanded clay, expanded shale, expanded perlite, recycled aggregate, non-expanded perlites, hollow silicatic microspheres, recycled plastic, ground rubber, biobased lightweight fillers, based on hemp, rice husks, wood or cork, or combinations thereof.

4. The one- or two-component mortar composition as claimed in claim 1, wherein the one or more lightweight fillers having a particle density of less than 1.5 g/cm³, have a mean grain size in the range from 0.05 to 16 mm.

5. The one- or two-component mortar composition as claimed in claim 1, wherein the content of filler having a particle density of at least 2.0 g/cm³ is 2% to 20% by weight, based on the dry weight of the mortar composition.

6. The one- or two-component mortar composition as claimed in claim 1, wherein the one or more fillers having a particle density of at least 2.0 g/cm³ comprise sand and/or calcium carbonate, the calcium carbonate being chalk and/or limestone flour.

7. The one- or two-component mortar composition as claimed in claim 1, wherein
the total amount of aluminate binder and calcium sulfate binder is 20% to 60% by weight, based on the dry weight of the mortar composition, and/or
the mortar composition further comprises at least one additive selected from a lithium salt, at least one retarder selected from tartaric acid or a tartaric acid salt, a gluconate, and citric acid or a citric acid salt, a plasticizer, or a combination thereof.

8. A screed comprising the one- or two-component mortar composition as claimed in claim 1.

9. A floor construction comprising, in this order, a first screed layer comprising the one- or two-component mortar composition as claimed in claim 1, a reinforcement layer and a second screed layer, there being optionally a floor covering arranged over the second screed layer.

10. A floor renovation and/or a wood substrate or a multi-layer substrate comprising a wood layer, comprising a layer comprising the one- or two-component mortar composition as claimed in claim 1.

11. A method for producing a floor construction on a substrate, comprising
a) applying a mixture of the mortar composition as claimed in claim 1 with water to the substrate, to form a first screed layer,
b) applying a reinforcement layer to the first screed layer,
c) applying a mixture of a leveling compound with water to the reinforcement layer, to form a second screed layer, and
d) optionally applying a floor covering to the second screed layer.

12. The method as claimed in claim 11, wherein
the reinforcement layer comprises a sheetlike textile carrier, and/or
the leveling compound is a calcium sulfate filling compound, the calcium sulfate filling compound comprising a calcium sulfate binder.

13. The method as claimed in claim 11, wherein
the first screed layer has a layer thickness in the range from 15 to 100 mm, and/or
the second screed layer has a layer thickness in the range from 6 to 50 mm.

14. A floor construction on a substrate, comprising in this order a first screed layer comprising the mortar composition as claimed in claim 1, a reinforcement layer and a second screed layer, there being optionally a floor covering arranged over the second screed layer.

15. The floor construction as claimed in claim 14, obtainable by a method comprising:
a) applying a mixture of the mortar composition with water to the substrate, to form a first screed layer,
b) applying a reinforcement layer to the first screed layer,
c) applying a mixture of a leveling compound with water to the reinforcement layer, to form a second screed layer, and
d) optionally applying a floor covering to the second screed layer.
